(19) United States
(12) Patent Application Publication
(10) Pub. No.: US 2022/0061233 A1
(43) Pub. Date: Mar. 3, 2022

(54) Collapsible and Height-Adjustable Plant Shade

(71) Applicant: David Wood PEACE, La Quinta, CA (US)

(72) Inventor: David Wood PEACE, La Quinta, CA (US)

(21) Appl. No.: 17/463,288

(22) Filed: Aug. 31, 2021

Related U.S. Application Data
(63) Continuation-in-part of application No. 29/795,083, filed on Jun. 16, 2021.
(60) Provisional application No. 63/072,336, filed on Aug. 31, 2020.

(51) Int. Cl. A01G 13/02

(52) U.S. Cl. CPC A01G 13/0206; A01G 2013/006

(57) ABSTRACT

A collapsible and height-adjustable plant shade is an apparatus that readily extends and retracts around a plant or multiple plants in order to protect the plant or multiple plants from extreme weather. The apparatus includes a scaffolding and a mesh covering. The scaffolding includes a plurality of length-adjustable legs, a collapsible lateral frame, and a roofing frame. Each of the plurality of length-adjustable legs may vary in height in order to accommodate uneven terrain. The collapsible lateral frame connects the plurality of length-adjustable legs with each other and mounts the roofing frame onto the plurality of length-adjustable legs. The mesh covering encloses the scaffolding and shields the plant or multiple plants. The apparatus further includes a plurality of extension lateral panels in order to account for any distance between the mesh frame and the ground due to varying heights of each of the plurality of length-adjustable legs.

The current application claims a priority to the U.S. provisional patent application Ser. No. 63/072,336 filed on Aug. 31, 2020.

The current application is a continuation-in-part (CIP) application of the U.S. design application Ser. No. 29/795,083 filed on Jun. 16, 2021.

### FIELD OF THE INVENTION

The present invention generally relates to gardening. More specifically, the present invention is a collapsible and height-adjustable plant shade that protects plants from extreme weather conditions such as heat or cold.

### BACKGROUND OF THE INVENTION

Temperature is one of the primary factors which affects the rate of plant development. Warmer temperatures expected with climate change and the potential for more extreme temperature events will impact plant productivity, similarly cold extreme temperatures have a critical impact as well. Pollination is one of the most sensitive phenological stages to temperature extremes across all species and during this developmental stage temperature extremes would greatly affect production.

Few adaptation strategies are available to cope with temperature extremes at this developmental stage other than to select for plants which shed pollen during the cooler periods of the day or are indeterminate, so flowering occurs over a longer period of the growing season. In controlled environment studies, warm temperatures increased the rate of phenological development; however, there was no effect on leaf area or vegetative biomass compared to normal temperatures.

The major impact of warmer temperatures was during the reproductive stage of development and in all cases grain yield in maize was significantly reduced by as much as 80-90% from a normal temperature regime.

Temperature effects are increased by water deficits and excess soil water demonstrating that understanding the interaction of temperature and water is needed to develop more effective adaptation strategies to offset the impacts of greater temperature extreme events associated with a changing climate.

Thus, it is the objective of the present invention to provide means to providing protection from extreme conditions for plants.

### BRIEF DESCRIPTION OF THE DRAWINGS

FIG. 1 is a top-front-left perspective view of the present invention;

FIG. 2 is a front side view of the present invention;

FIG. 3 is a left elevational cross-section view taken along line 9-9 in FIG. 3.

FIG. 4 is a rear side view of the present invention;

FIG. 5 is a left elevational cross-section view taken along line 9-9 in FIG. 3.

FIG. 6 is a top-front-left perspective view of the present invention with a plurality of extension lateral panels attached to a mesh covering with a plurality of second elongated fasteners;

### DETAIL DESCRIPTIONS OF THE INVENTION

All illustrations of the drawings are for the purpose of describing selected versions of the present invention and are not intended to limit the scope of the present invention.

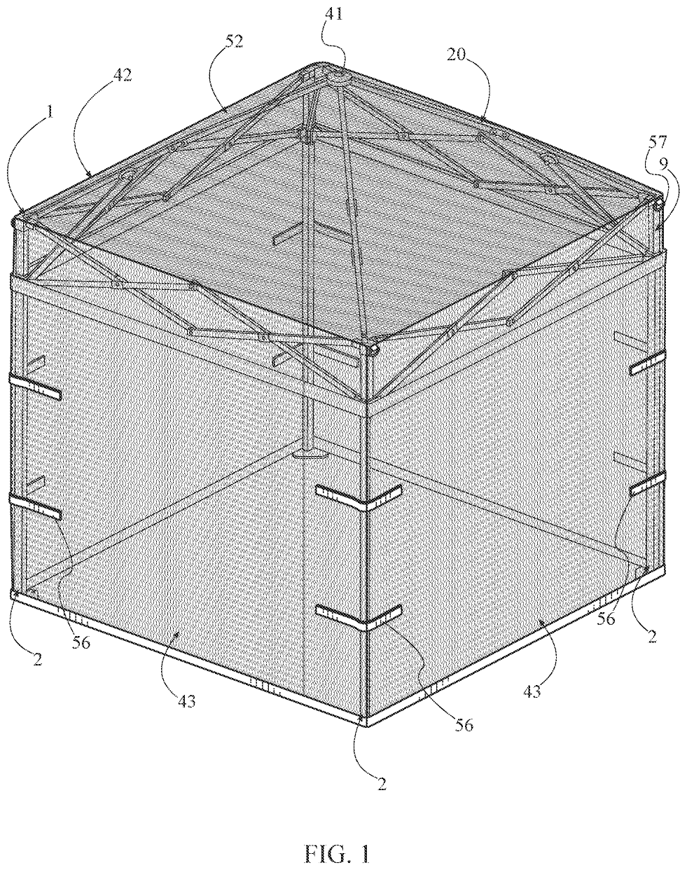

The present invention is a collapsible and height-adjustable plant shade. The present invention protects plants from extreme weather conditions. The present invention is a deployable plant protector that is easily collapsible and portable. Furthermore, the present invention is weatherproof and provides a breathable environment for the housed plants. A plant or multiple plants are protected by the present invention as the present invention may comprise a scaffolding 1 and a mesh covering 42, seen in FIG. 1. The scaffolding 1 defines a weatherproof area around the plants. Moreover, the scaffolding 1 upholds the mesh covering 42 around the plants. The scaffolding 1 may comprise a plurality of length-adjustable legs 2, a collapsible lateral frame 9, and a roofing frame 20. It is understood that the scaffolding 1 may be separable so that the present invention remains compact while in a storage configuration. The plurality of length-adjustable legs 2 defines the height for the scaffolding 1 and upholds the collapsible lateral frame 9. The plurality of length-adjustable legs 2 allows the present invention to be mounted onto uneven terrain. The collapsible lateral frame 9 connects each of the plurality of length-adjustable legs 2 with each other as well as extends and retracts the plurality of adjustable legs and the roofing frame 20. The roofing frame 20 supports the mesh covering 42 above the plants. In order for the entire scaffolding 1 to extend and retract continuously, the roofing frame 20 may comprise a plurality of collapsible arms 21. The collapsible arms 21 provide the structural support for the roofing frame 20 while being able to extend and retract. The mesh covering 42 shields the plants from extreme heat and cold while maintaining a breathable environment for the plants. Moreover, the mesh covering 42 allows sunlight to reach the plants.

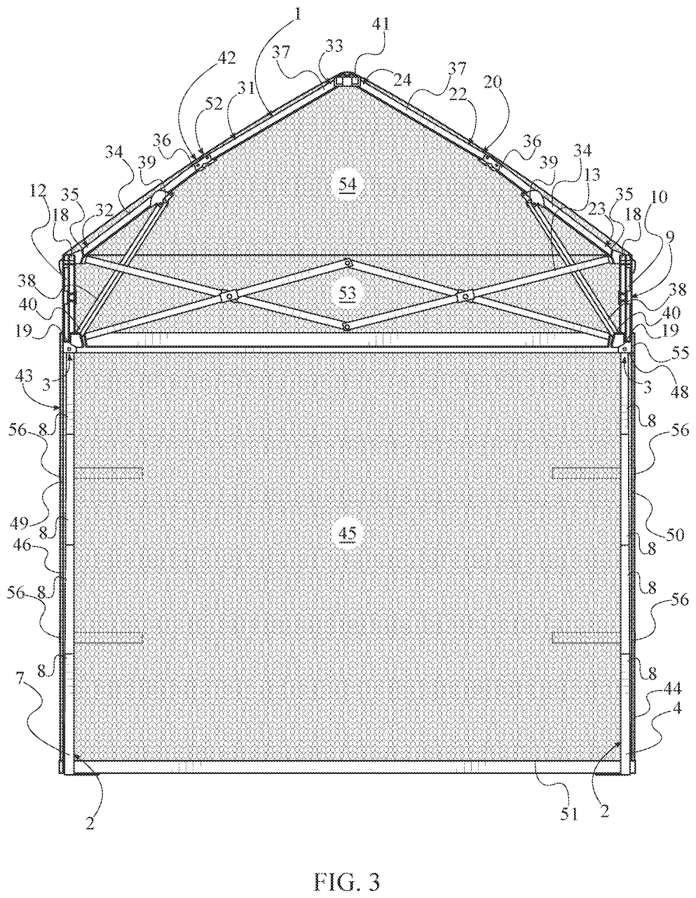

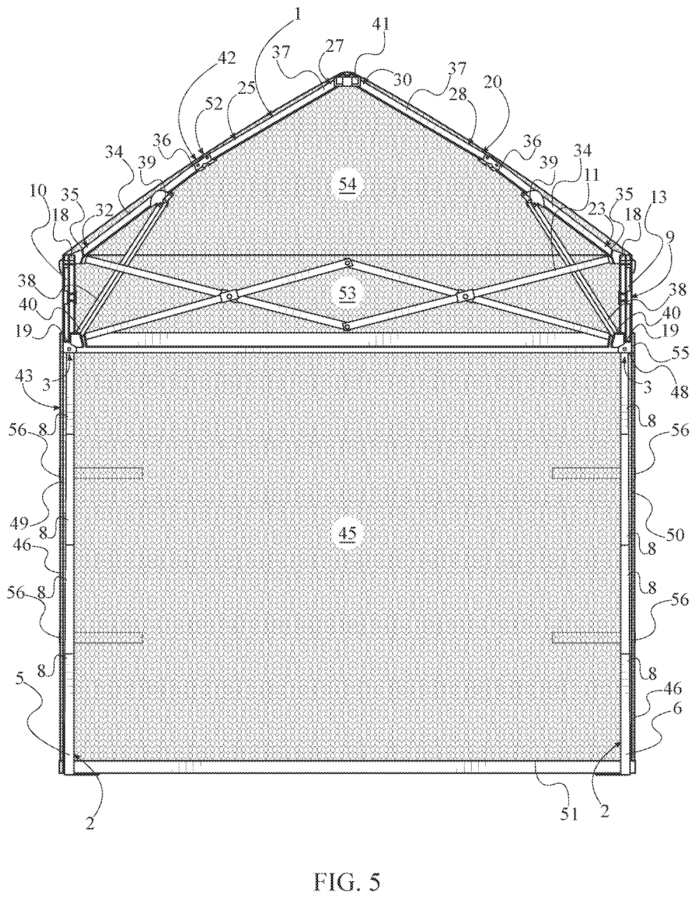

The overall configuration for the aforementioned components effectively protects plants across various terrains against extreme weather. The collapsible lateral frame 9 is balanced above the plants as a fixed end 3 of each of the plurality of length-adjustable legs 2 is attached adjacent with the collapsible lateral frame 9, seen in FIG. 3 and FIG. 5. In the preferred embodiment, the fixed end 3 of each of the plurality of telescopic legs is frictionally engaged into a first sleeve and an adjacent collapsible lateral frame 9 is frictionally engaged into a second sleeve. The first sleeve and the second sleeve are fixed to one another. An enclosure is defined around the plants by the scaffolding 1 as the roofing frame 20 is positioned adjacent with the collapsible lateral frame 9, opposite the plurality of length-adjustable legs 2. The plurality of collapsible arms 21 is hingedly connected with the collapsible lateral frame 9 so that the roofing frame 20 may simultaneously extend and retract with the collapsible lateral frame 9. The structural integrity of the scaffolding 1 is reinforced as the plurality of length-adjustable legs 2 and the plurality of collapsible arms 21 are distributed around the collapsible lateral frame 9. Each of the plurality of length-adjustable legs 2 is positioned normal with the collapsible lateral frame 9, maximizing the space within the present invention while maintaining a secure structure. The weight of the roofing frame 20 is effectively supported and balanced as each of the plurality of length-adjustable legs 2 is aligned with a corresponding collapsible arm of the plurality of collapsible arms 21. The mesh covering 42 is mounted over the scaffolding 1, thereby shielding the plants from extreme heat or cold.

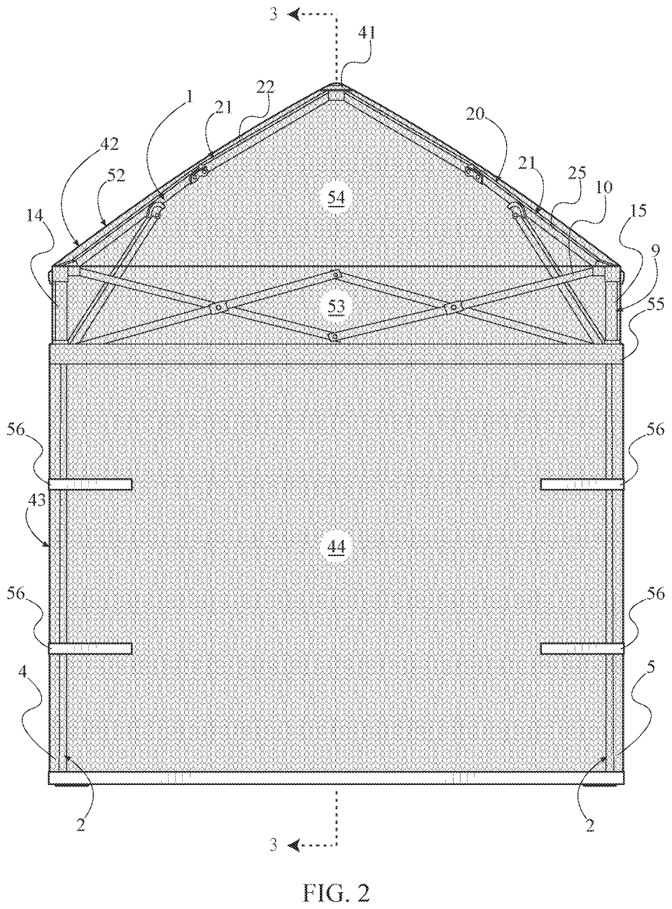

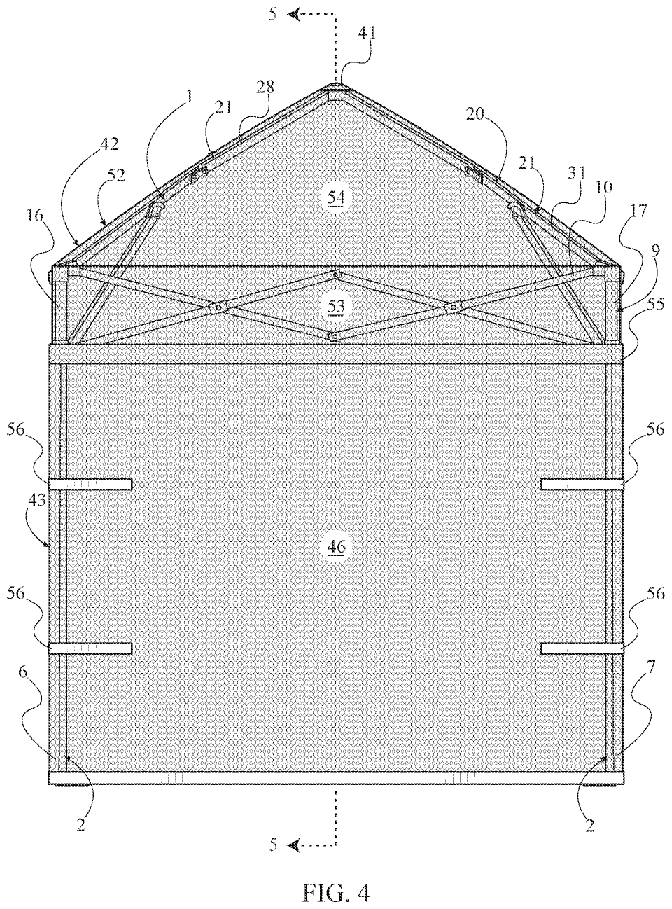

In the preferred embodiment of the present invention, the plurality of length-adjustable legs 2 comprises a first leg 4, a second leg 5, a third leg 6, and a fourth leg 7. Moreover, the collapsible lateral frame 9 may comprise a first side portion 10, a second side portion 11, a third side portion 12, a fourth side portion 13, a first corner post 14, a second corner post 15, a third corner post 16, and a fourth corner post 17, seen in FIG. 2, FIG. 3, FIG. 4, and FIG. 5. The first leg 4, the second leg 5, the third leg 6 and the fourth leg 7 evenly support the collapsible lateral frame 9. The first side portion 10, the second side portion 11, the third side portion 12, and the fourth side portion 13 define the overall shape of the collapsible lateral frame 9 and connects the first leg 4, the second leg 5, the third leg 6, and the fourth leg 7 with each other, respectively. The first corner post 14, the second corner post 15, the third corner post 16, and the fourth corner post 17 uphold the first side portion 10, the second side portion 11, the third side portion 12, and the fourth side portion 13 with the first leg 4, the second leg 5, the third leg 6, and the fourth leg 7, respectively. Moreover, the first corner post 14, the second corner post 15, the third corner post 16, and the fourth corner post 17 allow the collapsible lateral frame 9 to be easily collapsible with the first leg 4, the second leg 5, the third leg 6, and the fourth leg 7, respectively, while preserving the structural integrity of the collapsible lateral frame 9. In order for the first leg 4 to be extended and retracted with the second leg 5, the first side portion 10 is hingedly connected in between the first corner post 14 and the second corner post 15. In order for the second leg 5 to be extended and retracted with the third leg 6, the second side portion 11 is hingedly connected in between the second corner post 15 and the third corner post 16. In order for the third leg 6 to be extended and retracted with the fourth leg 7, the third side portion 12 is hingedly connected in between the third corner post 16 and the fourth corner post 17. In order for the fourth leg 7 to be extended and retracted with the first leg 4, the fourth side portion 13 is hingedly connected in between the fourth corner post 17 and the first corner post 14. The roofing frame 20 is effectively supported by collapsible lateral frame 9 with the first leg 4 as the first leg 4 is attached colinear with the first corner post 14. The roofing frame 20 is effectively supported by collapsible lateral frame 9 with the second leg 5 as the second leg 5 is attached colinear with the second corner post 15. The roofing frame 20 is effectively supported by collapsible lateral frame 9 with the third leg 6 as the third leg 6 is attached colinear with the third corner post 16. The roofing frame 20 is effectively supported by collapsible lateral frame 9 with the fourth leg 7 as the fourth leg 7 is attached colinear with the fourth corner post 17. More specifically, in order for the first side portion 10, the second side portion 11, the third side portion 12, and the fourth side portion 13 to readily collapse and remain structurally sound while extended, the first side portion 10, the second side portion 11, the third side portion 12, and the fourth side portion 13 are each a scissor mechanism.

In order for the plurality of length-adjustable legs 2 to be independently adjustable in length, each of the plurality of length-adjustable legs 2 may comprise a plurality of tubular members 8, seen in FIG. 3 and FIG. 5. The plurality of tubular members 8 defines the height of a respective length-adjustable leg of the plurality of length-adjustable legs 2. The plurality of tubular members 8 allows the roofing frame 20 to remain normal with the ground regardless of any uneven terrain. Each of the plurality of tubular members 8 remains connected to each other while defining varying heights as the plurality of tubular members 8 is telescopically engaged amongst each other.

The preferred embodiment of the present invention further comprises a plurality of collapsible arms 21 that comprises a first arm 22, a second arm 25, a third arm 28, and a fourth arm 31, seen in FIG. 2, FIG. 3, FIG. 4, and FIG. 5. The first arm 22, the second arm 25, the third arm 28, and the fourth arm 31 evenly uphold the mesh covering 42 above the collapsible lateral frame 9. More specifically, the first corner post 14, the second corner post 15, the third corner post 16, and the fourth corner post 17 are evenly distributed around the collapsible lateral frame 9. In order for the roofing frame 20 to collapse with the collapsible lateral frame 9 with the first arm 22, a proximal end 23 of the first arm 22 is hingedly connected with the first corner post 14. In order for the roofing frame 20 to collapse with the collapsible lateral frame 9 with the second arm 25, a proximal end 26 of the second arm 25 is hingedly connected with the second corner post 15. In order for the roofing frame 20 to collapse with the collapsible lateral frame 9 with the third arm 28, a proximal end 29 of the third arm 28 is hingedly connected with the third corner post 16. In order for the roofing frame 20 to collapse with the collapsible lateral frame 9 with the fourth arm 31, a proximal end 32 of the fourth arm 31 is hingedly connected with the fourth corner post 17. The first arm 22, the second arm 25, the third arm 28, and the fourth arm 31 are collapsible with each other as a distal end 24 of the first arm 22, a distal end 30 of the second arm 25, a distal end 30 of the third arm 28, and a distal end 33 of the fourth arm 31 are hingedly connected with each other. Furthermore, an apex 41 of the roofing frame 20 is the hinged connection between the distal end 24 of the first arm 22, the distal end 27 of the second arm 25, the distal end 30 of the third arm 28, and the distal end 33 of the fourth arm 31, further maximizing the space within the present invention. More specifically, the apex 41 of the roofing frame 20 is positioned offset from the collapsible lateral frame 9.

In order for the plurality of collapsible arms 21 to remain structurally sound while extended, each of the plurality of collapsible arms 21 may comprise a proximal bar 34, a distal bar 37, and a stabilizing bar 38, seen in FIG. 3 and FIG. 5. The proximal bar 34 connects the distal bar 37 with the collapsible lateral frame 9. The distal bar 37 connects the corresponding collapsible arm of the plurality of collapsible arms 21 with the remaining collapsible arms 21 of the plurality of collapsible arms 21. The stabilizing bar 38 supports the proximal bar 34, and consequently the distal bar 37. Both the proximal bar 34 and the stabilizing bar 38 are directly supported by the collapsible lateral frame 9 as the collapsible lateral frame 9 may comprise a first frame rim 18 and a second frame rim 19. The first frame rim 18 and the second frame rim 19 are positioned opposite with each other about the collapsible lateral frame 9, thereby defining the height of the collapsible lateral frame 9 while extended. More specifically, the first frame rim 18 is positioned adjacent with the plurality of collapsible arms 21, and the second frame rim 19 is positioned adjacent with the plurality of length-adjustable legs 2. Each of the plurality of collapsible arms 21 may extend and retract while connected to the collapsible lateral frame 9 and each other as a first end 35 of the proximal bar 34 is hingedly connected with the collapsible lateral frame 9, and a second end 36 of the proximal bar 34 is hingedly connected with a first end 35 of the distal bar 37. The proximal bar 34 is supported by the stabilizing bar 38 as a first end 35 of the stabilizing bar 38 is laterally positioned with the proximal bar 34. Similarly, the first end 35 of the stabilizing bar 38 is hingedly connected with the proximal bar 34, and a second end 36 of the stabilizing bar 38 is hingedly connected with the second frame rim 19, thereby defining and supporting the apex 41 of the roofing frame 20. This arrangement of the stabilizing bar 38 also further preserves the ability of each of the plurality of collapsible arms 21 to extend and retract while remaining connected to the collapsible lateral frame 9.

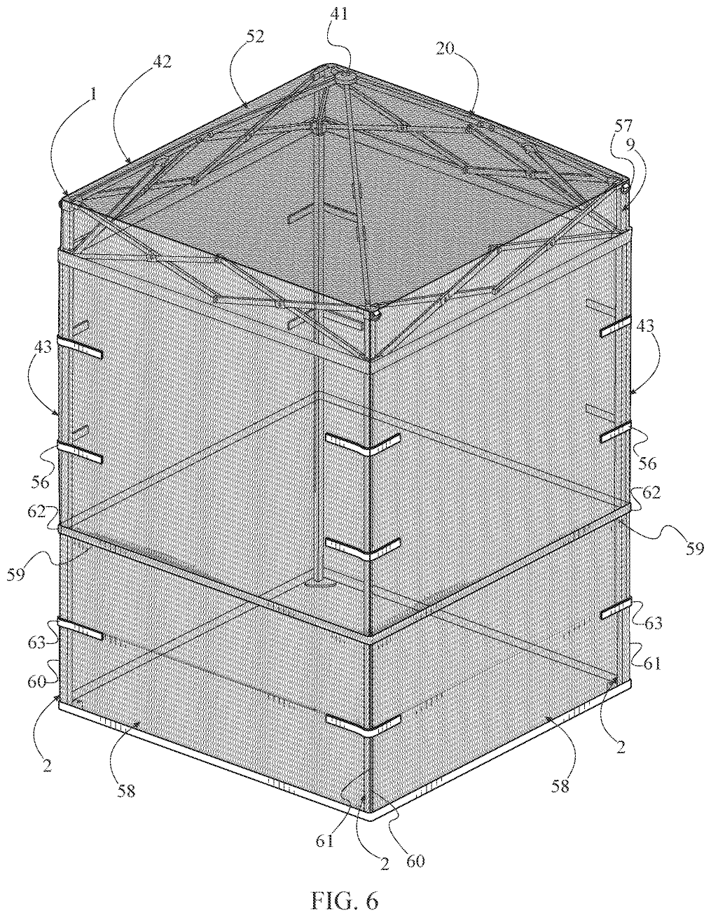

In order for the scaffolding 1 to be fully enclosed by the mesh covering 42, the mesh covering 42 may comprise a plurality of initial lateral panels 43 and a roofing cap 52, seen in FIG. 1, FIG. 2, FIG. 3, FIG. 4, FIG. 5, and FIG. 6. The plurality of initial lateral panels 43 surrounds the sides of the scaffolding 1. The roofing cap 52 covers the scaffolding 1. Moreover, the roofing cap 52 may comprise a lateral portion 53 and a capping portion 54 so that the roofing cap 52 is superimposed around both the collapsible lateral frame 9 and the roofing frame 20. The plurality of initial lateral panels 43 is positioned around the plurality of length-adjustable legs 2, thereby surrounding the sides of the scaffolding 1. The mesh covering 42 continuously surrounds the scaffolding 1 as the lateral portion 53 is positioned around the collapsible lateral frame 9, and the capping portion 54 is positioned across the roofing frame 20. The environment within the present invention is defined as the plurality of initial lateral panels 43 is positioned adjacent with the lateral portion 53, and the plurality of initial lateral panels 43 is distributed around the lateral portion 53. More specifically, the plurality of initial lateral panels 43 is perimetrically attached around the lateral portion 53. The capping portion 54 is positioned adjacent with the lateral portion 53, opposite the plurality of initial lateral panels 43, effectively enclosing the present invention around plants. More specifically, the capping portion 54 is perimetrically fixed around the lateral portion 53, maximizing the space within the present invention.

In the preferred embodiment of the present invention, the plurality of initial lateral panels 43 comprises a first panel 44, a second panel 45, a third panel 46, and a fourth panel 47, seen in FIG. 2, FIG. 3, FIG. 4, and FIG. 5. The first panel 44, the second panel 45, the third panel 46, and the fourth panel 47 each covers the space between the first leg 4, the second leg 5, the third leg 6, and the fourth leg 7. More specifically, the first panel 44, the second panel 45, the third panel 46, and the fourth panel 47 are arranged in a rectangular configuration.

In order to secure the plurality of initial lateral panels 43 with the lateral portion 53, the present invention may further comprise a plurality of first elongated fasteners 55, seen in FIG. 1, FIG. 2, FIG. 3, FIG. 4, FIG. 5, and FIG. 6. The plurality of first elongated fasteners 55 is preferably made of Velcro. The lateral portion 53 is attached along a top edge 48 of each of the plurality of initial lateral panels 43 by a corresponding first elongated fastener from the plurality of first elongated fasteners 55, thereby further insulating plants from extreme weather.

Similarly, the present invention may further comprise a plurality of first discrete fasteners 56 in order for the plurality of initial lateral panels 43 to be secured with each other, seen in FIG. 1, FIG. 2, FIG. 3, FIG. 4, FIG. 5, and FIG. 6. The plurality of first discrete fasteners 56 is preferably made of Velcro. In order to seal the plurality of initial lateral panels 43 with each other, a right edge 49 of an arbitrary initial lateral panel is attached along a left edge 50 of an adjacent initial lateral panel by at least one first discrete fastener from the plurality of first discrete fasteners 56, wherein the arbitrary initial lateral panel and the adjacent initial lateral panel are adjacent initial lateral panels from the plurality of initial lateral panels 43.

In order to mount the present invention into the ground, the present invention may further comprise a plurality of D-rings 57, seen in FIG. 1, FIG. 2, FIG. 3, FIG. 4, FIG. 5, and FIG. 6. The plurality of D-rings 57 serves to secure a ground stake with the mesh covering 42 with a string or a rope. Moreover, a ground stake is securely tethered to the mesh covering 42 with a D-ring of the plurality of D-rings 57. Multiple ground stakes may be effectively positioned around the present invention and connect with the present invention as the plurality of D-rings 57 is externally positioned with the mesh covering 42. The plurality of D-rings 57 is distributed around the lateral portion 53, evenly positioning multiple ground stakes around the present invention. The mesh covering 42, and consequently the scaffolding 1 remains pressed onto the ground as the plurality of b-rings 57 is fixed adjacent with the lateral portion 53. This arrangement pulls down on the roofing cap 52 so that the present invention is not blown away by the wind.

As the plurality of length-adjustable legs 2 are independently extendable and retractable, the present invention may further comprise a plurality of extension lateral panels 58, a plurality of second elongated fasteners 62, and a plurality of second discrete fasteners 63, seen in FIG. 6. The plurality of extension lateral panels 58 encloses the scaffolding 1 between the plurality of initial lateral panels 43 and the ground. The plurality of second elongated fasteners 62 connects the plurality of extension lateral panels 58 with the plurality of initial lateral panels 43. The plurality of discrete fasteners connects each of the plurality of extension lateral panels 58 with each other. In order to accommodate height differences among the plurality of length-adjustable legs 2, the plurality of extension lateral panels 58 is positioned around the plurality of length-adjustable legs 2. In order to further shield plants within the present invention from the extreme weather of the surrounding environment, a top edge 59 of each of the plurality of extension lateral panels 58 is attached along a bottom edge 51 of a corresponding initial lateral panel from the plurality of initial lateral panels 43 by a corresponding second elongated fastener from the plurality of second elongated fasteners 62. Each of the plurality of extension lateral panels 58 is secured with each other as a right edge 60 of an arbitrary extension lateral panel is attached along a left edge 61 of an adjacent extension lateral panel by at least one second discrete fastener from the plurality of second discrete fasteners 63, wherein the arbitrary extension lateral panel and the adjacent extension lateral panel are each positioned adjacent with a pair of extension lateral panels from the plurality of extension lateral panels 58.

Although the invention has been explained in relation to its preferred embodiment, it is to be understood that many other possible modifications and variations can be made without departing from the spirit and scope of the invention as hereinafter claimed.

What is claimed is:

1. A collapsible and height-adjustable plant shade comprises:
a scaffolding;
a mesh covering;
the scaffolding comprising a plurality of length-adjustable legs, a collapsible lateral frame, and a roofing frame;
the roofing frame comprising a plurality of collapsible arms;
a fixed end of each of the plurality of plurality of length-adjustable legs being attached adjacent with the collapsible lateral frame;
the roofing frame being positioned adjacent with the collapsible lateral frame, opposite the plurality of length-adjustable legs;
the plurality of collapsible arms being hingedly connected with the collapsible lateral frame;
the plurality of length-adjustable legs and the plurality of collapsible arms being distributed around the collapsible lateral frame;
each of the plurality of length-adjustable legs being positioned normal with the collapsible lateral frame;
each of the plurality of length-adjustable legs being aligned with a corresponding collapsible arm of the plurality of collapsible arms; and,
the mesh covering being mounted over the scaffolding.

2. The collapsible and height-adjustable plant shade as claimed in claim 1 comprises:
the plurality of length-adjustable legs comprising a first leg, a second leg, a third leg, and a fourth leg;
the collapsible lateral frame comprising a first side portion, a second side portion, a third side portion, a fourth side portion, a first corner post, a second corner post, a third corner post, and a fourth corner post;
the first side portion being hingedly connected in between the first corner post and the second corner post;
the second side portion being hingedly connected in between the second corner post and the third corner post;
the third side portion being hingedly connected in between the third corner post and the fourth corner post;
the fourth side portion being hingedly connected in between the fourth corner post and the first corner post;
the first leg being attached colinear with the first corner post;
the second leg being attached colinear with the second corner post;
the third leg being attached colinear with the third corner post; and,
the fourth leg being attached colinear with the fourth corner post.

3. The collapsible and height-adjustable plant shade as claimed in claim 2 comprises:
the first side portion, the second side portion, the third side portion, and the fourth side portion each being a scissor mechanism.

4. The collapsible and height-adjustable plant shade as claimed in claim 1 comprises:
each of the plurality of length-adjustable legs comprising a plurality of tubular members; and,
the plurality of tubular members being telescopically engaged amongst each other.

5. The collapsible and height-adjustable plant shade as claimed in claim 1 comprises:
the collapsible lateral frame comprising a first corner post, a second corner post, a third corner post, and a fourth corner post;
the plurality of collapsible arms comprising a first arm, a second arm, a third arm, and a fourth arm;
the first corner post, the second corner post, the third corner post, and the fourth corner post being evenly distributed around the collapsible lateral frame;
a proximal end of the first arm being hingedly connected with the first corner post;
a proximal end of the second arm being hingedly connected with the second corner post;
a proximal end of the third arm being hingedly connected with the third corner post;
a proximal end of the fourth arm being hingedly connected with the fourth corner post; and,
a distal end of the first arm, a distal end of the second arm, a distal end of the third arm, and a distal end of the fourth arm being hingedly connected with each other.

6. The collapsible and height-adjustable plant shade as claimed in claim 5 comprises:
an apex of the roofing frame being the hinged connection between the distal end of the first arm, the distal end of the second arm, the distal end of the third arm, and the distal end of the fourth arm; and,
the apex of the roofing frame being positioned offset from the collapsible lateral frame.

7. The collapsible and height-adjustable plant shade as claimed in claim 1 comprises:
each of the plurality of collapsible arms comprising a proximal bar, a distal bar, and a stabilizing bar;
the collapsible lateral frame comprising a first frame rim and a second frame rim;
the first frame rim and the second frame rim being positioned opposite with each other about the collapsible lateral frame;
the first frame rim being positioned adjacent with the plurality of collapsible arms;
the second frame rim being positioned adjacent with the plurality of length-adjustable legs;
a first end of the proximal bar being hingedly connected with the collapsible lateral frame;
a second end of the proximal bar being hingedly connected with a first end of the distal bar;
a first end of the stabilizing bar being laterally positioned with the proximal bar;
the first end of the stabilizing bar being hingedly connected with the proximal bar; and,
a second end of the stabilizing bar being hingedly connected with the second frame rim.

8. The collapsible and height-adjustable plant shade as claimed in claim 1 comprises:
the mesh covering comprising a plurality of initial lateral panels and a roofing cap;
the roofing cap comprises a lateral portion and a capping portion;
the plurality of initial lateral panels being positioned around the plurality of length-adjustable legs;
the lateral portion being positioned around the collapsible lateral frame;
the capping portion being positioned across the roofing frame;
the plurality of initial lateral panels being positioned adjacent with the lateral portion;
the plurality of initial lateral panels being distributed around the lateral portion;
the plurality of initial lateral panels being perimetrically attached around the lateral portion;
the capping portion being positioned adjacent with the lateral portion, opposite the plurality of initial lateral panels; and,
the capping portion being perimetrically fixed around the lateral portion.

9. The collapsible and height-adjustable plant shade as claimed in claim 8 comprises:
the plurality of initial lateral panels comprising a first panel, a second panel, a third panel, and a fourth panel; and,
the first panel, the second panel, the third panel, and the fourth panel being arranged in a rectangular configuration.

10. The collapsible and height-adjustable plant shade as claimed in claim 8 comprises:
a plurality of first elongated fasteners; and,
the lateral portion being attached along a top edge of each of the plurality of initial lateral panels by a corresponding first elongated fastener from the plurality of first elongated fasteners.

11. The collapsible and height-adjustable plant shade as claimed in claim 8 comprises:
a plurality of first discrete fasteners; and,
a right edge of an arbitrary initial lateral panel being attached along a left edge of an adjacent initial lateral panel by at least one first discrete fastener from the plurality of first discrete fasteners, wherein the arbitrary initial lateral panel and the adjacent initial lateral panel are adjacent initial lateral panels from the plurality of initial lateral panels.

12. The collapsible and height-adjustable plant shade as claimed in claim 8 comprises:
a plurality of D-rings;
the plurality of D-rings being externally positioned with the mesh covering;
the plurality of D-rings being distributed around the lateral portion; and,
the plurality of D-rings being fixed adjacent with the lateral portion.

13. The collapsible and height-adjustable plant shade as claimed in claim 8 comprises:
a plurality of extension lateral panels;
a plurality of second elongated fasteners;
a plurality of second discrete fasteners;
the plurality of extension lateral panels being positioned around the plurality of length-adjustable legs;
a top edge of each of the plurality of extension lateral panels being attached along a bottom edge of a corresponding initial lateral panel from the plurality of initial lateral panels by a corresponding second elongated fastener from the plurality of second elongated fasteners; and,
a right edge of an arbitrary extension lateral panel being attached along a left edge of an adjacent extension lateral panel by at least one second discrete fastener from the plurality of second discrete fasteners, wherein the arbitrary extension lateral panel and the adjacent extension lateral panel are adjacent pair of extension lateral panels from the plurality of extension lateral panels.

14. A collapsible and height-adjustable plant shade comprises:
a scaffolding;
a mesh covering;
a plurality of extension lateral panels;
a plurality of second elongated fasteners;
a plurality of second discrete fasteners;
a plurality of D-rings;
a plurality of first elongated fasteners;
a plurality of first discrete fasteners;
the mesh covering comprising a plurality of initial lateral panels and a roofing cap;
the scaffolding comprising a plurality of length-adjustable legs, a collapsible lateral frame, and a roofing frame;
the roofing frame comprising a plurality of collapsible arms;
a fixed end of each of the plurality of plurality of length-adjustable legs being attached adjacent with the collapsible lateral frame;
the roofing frame being positioned adjacent with the collapsible lateral frame, opposite the plurality of length-adjustable legs;
the plurality of collapsible arms being hingedly connected with the collapsible lateral frame;
the plurality of length-adjustable legs and the plurality of collapsible arms being distributed around the collapsible lateral frame;
each of the plurality of length-adjustable legs being positioned normal with the collapsible lateral frame;
each of the plurality of length-adjustable legs being aligned with a corresponding collapsible arm of the plurality of collapsible arms;
the mesh covering being mounted over the scaffolding;
the roofing cap comprises a lateral portion and a capping portion;
the plurality of initial lateral panels being positioned around the plurality of length-adjustable legs;
the lateral portion being positioned around the collapsible lateral frame;
the capping portion being positioned across the roofing frame;
the plurality of initial lateral panels being positioned adjacent with the lateral portion;
the plurality of initial lateral panels being distributed around the lateral portion;
the plurality of initial lateral panels being perimetrically attached around the lateral portion;
the capping portion being positioned adjacent with the lateral portion, opposite the plurality of initial lateral panels;
the capping portion being perimetrically fixed around the lateral portion;
the plurality of extension lateral panels being positioned around the plurality of length-adjustable legs;
a top edge of each of the plurality of extension lateral panels being attached along a bottom edge of a corresponding initial lateral panel from the plurality of initial lateral panels by a corresponding second elongated fastener from the plurality of second elongated fasteners;
a right edge of an arbitrary extension lateral panel being attached along a left edge of an adjacent extension lateral panel by at least one second discrete fastener from the plurality of second discrete fasteners, wherein the arbitrary extension lateral panel and the adjacent extension lateral panel are adjacent pair of extension lateral panels from the plurality of extension lateral panels;
the plurality of D-rings being externally positioned with the mesh covering;
the plurality of D-rings being distributed around the lateral portion;
the plurality of D-rings being fixed adjacent with the lateral portion;
the lateral portion being attached along a top edge of each of the plurality of initial lateral panels by a corresponding first elongated fastener from the plurality of first elongated fasteners; and,
a right edge of an arbitrary initial lateral panel being attached along a left edge of an adjacent initial lateral panel by at least one first discrete fastener from the plurality of first discrete fasteners, wherein the arbitrary initial lateral panel and the adjacent initial lateral panel are adjacent initial lateral panels from the plurality of initial lateral panels.

15. The collapsible and height-adjustable plant shade as claimed in claim 14 comprises:
the plurality of length-adjustable legs comprising a first leg, a second leg, a third leg, and a fourth leg;
the collapsible lateral frame comprising a first side portion, a second side portion, a third side portion, a fourth side portion, a first corner post, a second corner post, a third corner post, and a fourth corner post;
the first side portion, the second side portion, the third side portion, and the fourth side portion each being a scissor mechanism.
the first side portion being hingedly connected in between the first corner post and the second corner post;
the second side portion being hingedly connected in between the second corner post and the third corner post;
the third side portion being hingedly connected in between the third corner post and the fourth corner post;
the fourth side portion being hingedly connected in between the fourth corner post and the first corner post;
the first leg being attached colinear with the first corner post;
the second leg being attached colinear with the second corner post;
the third leg being attached colinear with the third corner post; and,
the fourth leg being attached colinear with the fourth corner post.

16. The collapsible and height-adjustable plant shade as claimed in claim 14 comprises:
each of the plurality of length-adjustable legs comprising a plurality of tubular members; and,
the plurality of tubular members being telescopically engaged amongst each other.

17. The collapsible and height-adjustable plant shade as claimed in claim 14 comprises:
the collapsible lateral frame comprising a first corner post, a second corner post, a third corner post, and a fourth corner post;
the plurality of collapsible arms comprising a first arm, a second arm, a third arm, and a fourth arm;
the first corner post, the second corner post, the third corner post, and the fourth corner post being evenly distributed around the collapsible lateral frame;
a proximal end of the first arm being hingedly connected with the first corner post;
a proximal end of the second arm being hingedly connected with the second corner post;
a proximal end of the third arm being hingedly connected with the third corner post;
a proximal end of the fourth arm being hingedly connected with the fourth corner post;
a distal end of the first arm, a distal end of the second arm, a distal end of the third arm, and a distal end of the fourth arm being hingedly connected with each other;
an apex of the roofing frame being the hinged connection between the distal end of the first arm, the distal end of the second arm, the distal end of the third arm, and the distal end of the fourth arm; and,
the apex of the roofing frame being positioned offset from the collapsible lateral frame.

18. The collapsible and height-adjustable plant shade as claimed in claim 14 comprises:
each of the plurality of collapsible arms comprising a proximal bar, a distal bar, and a stabilizing bar;
the collapsible lateral frame comprising a first frame rim and a second frame rim;
the first frame rim and the second frame rim being positioned opposite with each other about the collapsible lateral frame;
the first frame rim being positioned adjacent with the plurality of collapsible arms;
the second frame rim being positioned adjacent with the plurality of length-adjustable legs;
a first end of the proximal bar being hingedly connected with the collapsible lateral frame;
a second end of the proximal bar being hingedly connected with a first end of the distal bar;
a first end of the stabilizing bar being laterally positioned with the proximal bar;
the first end of the stabilizing bar being hingedly connected with the proximal bar; and,
a second end of the stabilizing bar being hingedly connected with the second frame rim.

19. The collapsible and height-adjustable plant shade as claimed in claim 14 comprises:
the plurality of initial lateral panels comprising a first panel, a second panel, a third panel, and a fourth panel; and,
the first panel, the second panel, the third panel, and the fourth panel being arranged in a rectangular configuration.

20. The collapsible and height-adjustable plant shade as claimed in claim 14 comprises:
a plurality of D-rings;
the plurality of D-rings being externally positioned with the mesh covering;
the plurality of D-rings being distributed around the lateral portion; and,
the plurality of D-rings being fixed adjacent with the lateral portion.
